(19) United States
(12) Patent Application Publication
(10) Pub. No.: US 2026/0192597 A1
(43) Pub. Date: Jul. 9, 2026

(54) WHEEL BEARING AND SHAFT FOR VEHICLE

(71) Applicant: GM GLOBAL TECHNOLOGY OPERATIONS LLC, DETROIT, MI (US)

(72) Inventors: Andrew West, Southfield, MI (US); Craig S. Ross, Ypsilanti, MI (US)

(21) Appl. No.: 19/013,602

(22) Filed: Jan. 8, 2025

(51) Int. Cl. B60B 27/00; B60B 35/18

(52) U.S. Cl. CPC B60B 27/0005; B60B 35/18; B60B 2310/50; B60B 2380/12

(57) ABSTRACT

An axle assembly of a vehicle includes an axle including an inner shaft, an outer shaft, and a socket at a connection of the inner shaft to the outer shaft. A hub is secured to the outer shaft. The axle assembly includes a bearing assembly having a bearing outer race, a bearing inner race, and a plurality of bearing elements positioned between the bearing outer race and the bearing inner race. The bearing inner race is at least partially defined by the axle.

### BACKGROUND

The subject disclosure relates to vehicles, and in particular to wheel systems for vehicles.

Vehicle wheels and axles or shafts are positioned and supported by wheel bearings including an inner race at the shaft, an outer race radially outboard of the inner race, and bearing elements located between the inner race and the outer race. In some configurations, noise vibration and harshness (NVH) problems occur in the system due to conditions such as a high torque induced microslip between the wheel bearing and the shaft. The art would appreciate advancements to alleviate these NVH problems.

### SUMMARY

In one exemplary embodiment, an axle assembly of a vehicle includes an axle including an inner shaft, an outer shaft, and a socket at a connection of the inner shaft to the outer shaft. A hub is secured to the outer shaft. The axle assembly includes a bearing assembly having a bearing outer race, a bearing inner race, and a plurality of bearing elements positioned between the bearing outer race and the bearing inner race. The bearing inner race is at least partially defined by the axle.

In addition to one or more of the features described herein the bearing inner race includes at least one inner raceway defined in a socket outer surface of the socket in which at least a portion of the plurality of bearing elements is positioned.

In addition to one or more of the features described herein the inner shaft and the outer shaft are connected at a constant velocity joint.

In addition to one or more of the features described herein the hub includes a hub body, and a hub flange extending radially outwardly from the hub body.

In addition to one or more of the features described herein the inner bearing race includes at least one outer raceway defined in the hub body in which at least a portion of the plurality of bearing elements is positioned.

In addition to one or more of the features described herein the hub flange is configured for securing a wheel thereto.

In addition to one or more of the features described herein the bearing inner race includes an outer raceway defined in the hub having a first portion of the plurality of bearing elements positioned thereat, and an inner raceway defined in a socket outer surface of the socket having a second portion of the plurality of bearing elements positioned thereat.

In addition to one or more of the features described herein the inner raceway is formed by one or more heat treatment operations one the socket.

In addition to one or more of the features described herein the hub includes a central opening through which the outer shaft extends.

In addition to one or more of the features described herein the hub is secured to the outer shaft via deformation of an outer shaft end.

In another exemplary embodiment, a vehicle includes a vehicle body, a propulsion system, and a plurality of wheels. A wheel of the plurality of wheels is connected to an axle assembly including an axle having an inner shaft, an outer shaft, and a socket at a connection of the inner shaft to the outer shaft. A hub is secured to the outer shaft. The axle assembly includes a bearing assembly having a bearing outer race, a bearing inner race, and a plurality of bearing elements positioned between the bearing outer race and the bearing inner race. The bearing inner race is at least partially defined by the axle.

In addition to one or more of the features described herein the bearing inner race includes at least one inner raceway defined in a socket outer surface of the socket in which at least a portion of the plurality of bearing elements is positioned.

In addition to one or more of the features described herein the inner shaft and the outer shaft are connected at a constant velocity joint.

In addition to one or more of the features described herein the hub includes a hub body, and a hub flange extending radially outwardly from the hub body.

In addition to one or more of the features described herein the inner bearing race includes at least one outer raceway defined in the hub body in which at least a portion of the plurality of bearing elements is positioned.

In addition to one or more of the features described herein the wheel is secured to the hub flange.

In addition to one or more of the features described herein the bearing inner race includes an outer raceway defined in the hub having a first portion of the plurality of bearing elements disposed thereat, and an inner raceway defined in a socket outer surface of the socket having a second portion of the plurality of bearing elements positioned thereat.

In addition to one or more of the features described herein the inner raceway is formed by one or more heat treatment operations one the socket.

In addition to one or more of the features described herein the hub includes a central opening through which the outer shaft extends.

In addition to one or more of the features described herein the hub is secured to the outer shaft via deformation of an outer shaft end.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of an exemplary embodiment of a vehicle; and

FIG. 2 is a cross-sectional view of an embodiment of a wheel and shaft assembly of a vehicle.

### DETAILED DESCRIPTION

The following description is merely exemplary in nature and is not intended to limit the present disclosure, its application or uses. It should be understood that throughout the drawings, corresponding reference numerals indicate like or corresponding parts and features.

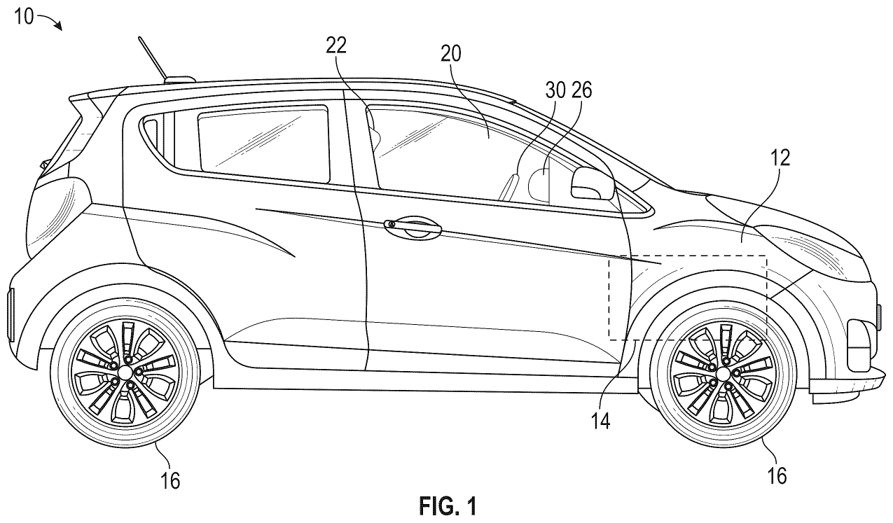

In accordance with an exemplary embodiment a vehicle, in accordance with a non-limiting example, is indicated generally at 10 in FIG. 1. Vehicle 10 includes a body 12 supported on a plurality of wheels 16 connected to a propulsion system 14, such as an engine. In a non-limiting example, two of the plurality of wheels 16 are steerable. Body 12 defines, in part, an occupant compartment 20 having seats 22 positioned behind a dashboard 26. A steering control 30 is arranged between seats 22 and dashboard 26. Steering control 30 is operated to control orientation of the steerable wheel(s) 16.

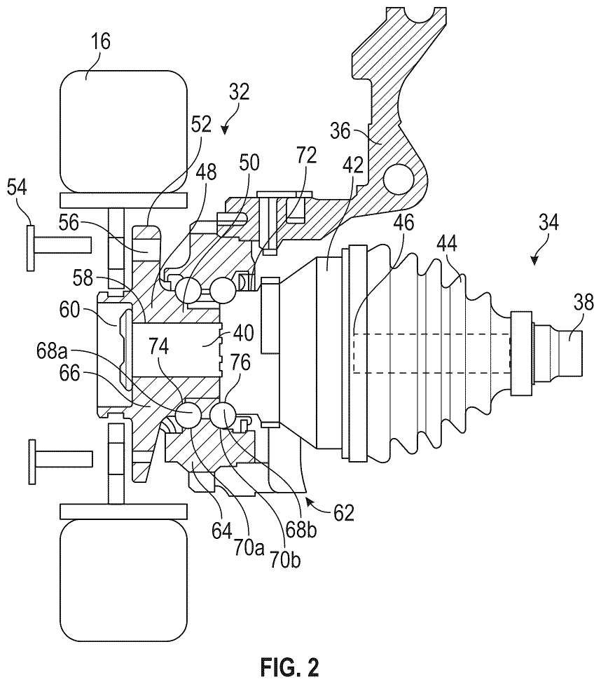

Referring now to FIG. 2, an exemplary wheel assembly 16 is secured to the vehicle 10 at a hub and bearing assembly 32 mounted on an axle assembly 34, for example, a constant velocity (CV) joint axle assembly 34, such as illustrated in FIG. 2. The hub and bearing assembly 32 and the axle assembly 34 are mounted to the vehicle 10 at, for example, a suspension member 36. The axle assembly 34 includes an inner shaft 38 coupled to an outer shaft 40 at a socket 42. A boot 44 covers the coupling 46 of the inner shaft 38 to the outer shaft 40 to protect the coupling 46 from contaminants. The hub and bearing assembly 32 includes a hub 48 to which the wheel assembly 16 is secured. The hub 48 includes a hub body 50 and a hub flange 52 extending outwardly from the hub body 50. In some embodiments, the wheel assembly 16 is secured to the hub 48 via, for example, fasteners 54 extending through the wheel 16 and into fastener openings 56 of the hub flange 52. The hub 48 further includes a central opening 58 in the hub body 50 through which the outer shaft 40 extends. The outer shaft 40 is secured to the hub 48 at the central opening 58 by, for example, orbital forming of an outer shaft end 60 to deform the outer shaft end 60 so it is retained at the central opening 58.

The hub and bearing assembly 32 includes a bearing assembly 62 having an outer race 64, an inner race 66 and a plurality of bearing elements 68 positioned between the outer race 64 and the inner race 66. The outer race 64 is assembled to, and in some embodiments is secured to, the suspension member 36, and defines two outer raceways 70a and 70b, also referred to herein as 70, receivable of bearing elements 68. The outer raceways 70 are axially spaced apart along the outer race 64.

The inner race 66 is partially defined by the hub body 50 and partially defined by a socket outer surface 72 of the socket 42. A first inner raceway 74 is located in the hub body 50 and a second inner raceway 76 is located in the socket outer surface 72. The second inner raceway 76 is formed in the socket outer surface 72 by, for example, one or more grinding or milling and heat treatment operations. In the bearing assembly 62, a first plurality of bearing elements 68a is located in a first outer raceway 70a and the first inner raceway 74 defined in the hub body 50, and a second plurality of bearing elements 68b is located in a second outer raceway 70b and the second inner raceway 76 defined in the socket outer surface 72.

This configuration allows the hub and bearing assembly 32 to be combined with the axle assembly 34 as a unitary assembly prior to installation into the vehicle 10 as a unitary assembly. This integration of the bearing assembly 62 into the axle assembly 34 by inclusion of the second inner raceway 76 defined in the socket outer surface 72 addresses the noise vibration and harshness (NVH) incidents seen in other configurations, and further provides a new and innovative assembly configuration.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An axle assembly of a vehicle, comprising:
an axle including:
an inner shaft;
an outer shaft;
a socket at a connection of the inner shaft to the outer shaft;
a hub secured to the outer shaft; and
a bearing assembly including:
a bearing outer race;
a bearing inner race; and
a plurality of bearing elements disposed between the bearing outer race and the bearing inner race;
wherein the bearing inner race is at least partially defined by the axle.

2. The axle assembly of claim 1, wherein the bearing inner race includes at least one inner raceway defined in a socket outer surface of the socket in which at least a portion of the plurality of bearing elements is disposed.

3. The axle assembly of claim 1, wherein the inner shaft and the outer shaft are connected at a constant velocity joint.

4. The axle assembly of claim 1, wherein the hub includes:
a hub body; and
a hub flange extending radially outwardly from the hub body.

5. The axle assembly of claim 4, wherein the inner bearing race includes at least one outer raceway defined in the hub body in which at least a portion of the plurality of bearing elements is disposed.

6. The axle assembly of claim 4, wherein the hub flange is configured for securing a wheel thereto.

7. The axle assembly of claim 1, wherein the bearing inner race includes:
an outer raceway defined in the hub having a first portion of the plurality of bearing elements disposed thereat; and
an inner raceway defined in a socket outer surface of the socket having a second portion of the plurality of bearing elements disposed thereat.

8. The axle assembly of claim 7, wherein the inner raceway is formed by one or more heat treatment operations one the socket.

9. The axle assembly of claim 1, wherein the hub includes a central opening through which the outer shaft extends.

10. The axle assembly of claim 9, wherein the hub is secured to the outer shaft via deformation of an outer shaft end.

11. A vehicle, comprising:
a vehicle body;
a propulsion system; and
a plurality of wheel assemblies, a wheel assembly of the plurality of wheel assemblies connected to an axle assembly including:
an axle including:
an inner shaft;
an outer shaft;
a socket at a connection of the inner shaft to the outer shaft;
a hub secured to the outer shaft; and
a bearing assembly including:
a bearing outer race;
a bearing inner race; and
a plurality of bearing elements disposed between the bearing outer race and the bearing inner race;
wherein the bearing inner race is at least partially defined by the axle.

12. The vehicle of claim 11, wherein the bearing inner race includes at least one inner raceway defined in a socket outer surface of the socket in which at least a portion of the plurality of bearing elements is disposed.

13. The vehicle of claim 11, wherein the inner shaft and the outer shaft are connected at a constant velocity joint.

14. The vehicle of claim 11, wherein the hub includes:
a hub body; and
a hub flange extending radially outwardly from the hub body.

15. The vehicle of claim 14, wherein the inner bearing race includes at least one outer raceway defined in the hub body in which at least a portion of the plurality of bearing elements is disposed.

16. The vehicle of claim 14, wherein the wheel is secured to the hub flange.

17. The vehicle of claim 11, wherein the bearing inner race includes:
an outer raceway defined in the hub having a first portion of the plurality of bearing elements disposed thereat; and
an inner raceway defined in a socket outer surface of the socket having a second portion of the plurality of bearing elements disposed thereat.

18. The vehicle of claim 17, wherein the inner raceway is formed by one or more heat treatment operations one the socket.

19. The vehicle of claim 11, wherein the hub includes a central opening through which the outer shaft extends.

20. The vehicle of claim 19, wherein the hub is secured to the outer shaft via deformation of an outer shaft end.
